(19) United States
(12) Patent Application Publication
(10) Pub. No.: US 2016/0184897 A1
(43) Pub. Date: Jun. 30, 2016

(54) METHOD OF PRODUCING A THREE-DIMENSIONAL COMPONENT

(71) Applicant: Caterpillar Inc., Peoria, IL (US)

(72) Inventor: Zachary Steven Birky, Washington, IL (US)

(73) Assignee: Caterpillar Inc., Peoria, IL (US)

(21) Appl. No.: 15/065,883

(22) Filed: Mar. 10, 2016

(51) Int. Cl. B22F 3/26; C23C 8/32; C23C 8/26; C23C 8/22; B22F 5/10; C21D 1/18

(52) U.S. Cl. CPC B22F 3/26; B22F 5/10; C21D 1/18; C23C 8/26; C23C 8/22; C23C 8/32; B33Y 10/00

(57) ABSTRACT

A method of producing a hardened component includes forming a 3-dimensional (3D) structure using an additive manufacturing process. The method includes forming the 3D structure using the additive manufacturing process and defining one or more passages there within. The method further includes heating the 3D structure in a pre-defined chamber to increase a temperature of the 3D structure to a pre-determined value. The method thereafter includes performing at least one of: infusing the plurality of passages defined in the heated 3D structure with a gaseous medium for at least a pre-defined period of time, and quenching the plurality of passages in the 3D structure with a quenching fluid for a pre-defined period of time.

### TECHNICAL FIELD

The present disclosure generally relates to three-dimensional components that may be produced using an additive manufacturing technique. More particularly, the disclosure relates to methods of post processing the three-dimensional components produced from the additive manufacturing technique.

### BACKGROUND

Various manufacturing techniques have been used to produce components with a desired amount of hardness. In some cases, the produced components may be additionally subjected to various heat-treatment processes for strengthening the component to a desired hardness level or value. Some examples of manufacturing techniques and heat-treatment processes may include, but are not limited to, forging, annealing, quenching, and the like. However, in many cases, it has been observed that the production of the components using traditionally known techniques to the desired hardness may be expensive and cumbersome.

U.S. Patent Publication No. 2015/0086408 (hereinafter referred to as the '408 reference) discloses a method of manufacturing a component and a method of thermal management. The methods include forming at least one portion of the component, printing a cooling member of the component and attaching the at least one portion of the component to the cooling member of the component. The cooling member includes at least one cooling feature. The cooling feature includes at least one cooling channel adjacent to a surface of the component, wherein printing allows for near-net shape geometry of the cooling member with the at least one cooling channel being located within a range of about 127 micrometers (0.005 inches) to about 762 micrometers (0.030 inches) from the surface of the component. The method of thermal management also includes transporting a fluid through at least one fluid pathway defined by the at least one cooling channel within the component to cool the component.

Although the '408 reference discloses that a cooling member being printed and attached onto the portion of the cooling component, the cooling channel located in the component is adjacently located with respect to the surface, is used only for extracting heat from the component but do not improve material characteristics of the component.

Hence, there exists a need for a manufacturing technique that is cost-effective while also being capable of achieving a pre-designed distribution of desired or required hardness and strength in the component.

### SUMMARY OF THE DISCLOSURE

In one aspect of the present disclosure, a method of producing a three-dimensional (3D) component includes forming a 3D structure using an additive manufacturing process, wherein forming the 3D structure includes defining one or more passages in the 3D structure using the additive manufacturing process. The method further includes heating the 3D structure in a pre-defined chamber to increase a temperature of the 3D structure to a pre-determined value. The method thereafter includes performing at least one of: infusing the plurality of passages defined in the heated 3D structure with a gaseous medium for at least a pre-defined period of time, and quenching the one or more passages in the 3D structure with a quenching fluid for a pre-defined period of time.

Other features and aspects of this disclosure will be apparent from the following description and the accompanying drawings.

### BRIEF DESCRIPTION OF THE DRAWINGS

FIG. 1 is a cross sectional view of a 3-dimensional structure that is formed using an additive manufacturing process in accordance with an embodiment of the present disclosure;

FIG. 2 is a cross sectional view of the 3-dimensional structure showing interconnected passages defined therein in accordance with an embodiment of the present disclosure;

FIG. 3 is a diagrammatic view of heating the 3-dimensional structure in accordance with an embodiment of the present disclosure;

FIG. 4 is a cross sectional view of the 3-dimensional structure showing infusion of a gaseous medium under the presence of heat into the passages of the 3-dimensional structure in accordance with an embodiment of the present disclosure;

FIG. 5 is a diagrammatic view of the 3-dimensional structure being quenched, in accordance with one embodiment of the present disclosure;

FIG. 6 is a cross sectional view of the 3-dimensional structure being quenched, in accordance with another embodiment of the present disclosure; and

FIG. 7 is a flowchart depicting a method of producing a three-dimensional component, in accordance with embodiments of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

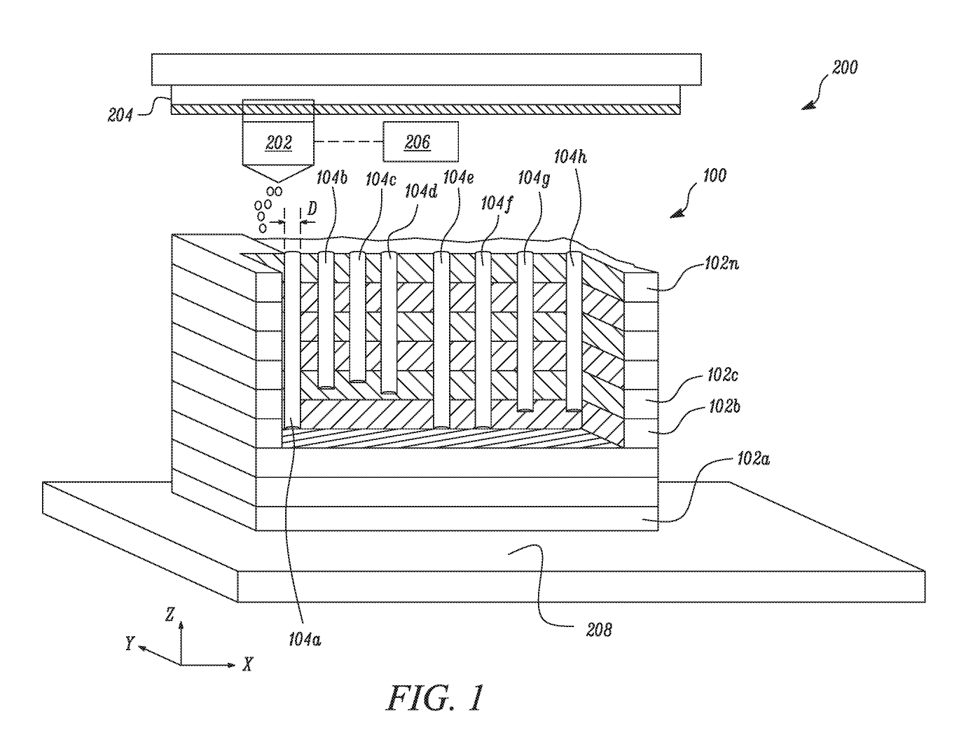

The present disclosure relates to a method of producing a hardened component. FIG. 1 shows a cross sectional view of a 3-dimensional (3D) component 100 (herein after interchangeably referred to as component or traced component) that is formed using an additive manufacturing process in accordance with an embodiment of the present disclosure. Although the present disclosure is explained in conjunction with a box-shaped component as shown in FIG. 1, it should be noted that embodiments disclosed herein may be similarly applied to form components of other sizes, shapes, and/or configurations without deviating from the spirit of the present disclosure.

In an embodiment as shown in FIG. 1, a 3D printing system 200 may be configured to trace the component 100 by depositing a material(s) successively in a layer-by-layer process that is characteristic of and consistent with the additive manufacturing process described herein. The 3D printing system 200 may include a print head 202 that is movably supported on a supporting fixture 204 such as for e.g., a gantry. The print head 202 may be moved along the supporting fixture 204 in three different axes namely—X-axis, Y-axis, and Z-axis for successively depositing the material(s) in layers as shown in FIG. 1. Moreover, the material(s) disclosed herein may be a single material or a combination of materials for e.g., a resin binder and a powder material in which the powder material may be crystalline or amorphous, but is not limited thereto.

Additionally, the 3D printing system 200 may also include a control system 206 that is communicably coupled to the print head 202. The control system 206 may be configured to issue appropriate commands, in digital or analog form, for controlling a movement of the print head 202. The commands issued by the control system 206 may be based on a 3-dimensional (3D) design data of the component 100 to be traced. The print head 202 may therefore, trace patterns of movement in accordance with the 3D design data for depositing the material(s) in layers pursuant to forming the component 100. The control system 206 may be configured to implement suitable programs, algorithms and/or other control logic including, but not limited to, the 3D design data for controlling a movement of the print head 202.

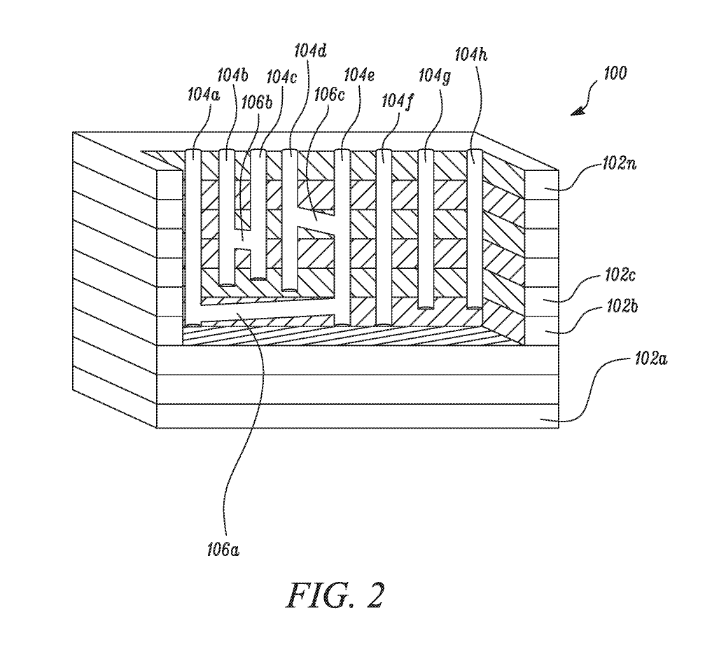

As shown, a first layer 102a of the material(s) may be deposited by the print head 202 on a support surface 208 that may be easily detached from the component 100 after formation of the component 100 is completed using the additive manufacturing process, in accordance with embodiments disclosed herein. Thereafter, subsequent layers 102b, 102c, 102n may be deposited on the first layer 102a in the layer-by-layer manner. Further, as shown in FIG. 2, the print head 202 is also configured to skip a deposition of the material(s) while forming the component 100 to define one or more passages 104a-h (herein after collectively denoted as numeral 104, unless referring to a particular passage) within a geometry of the component 100. As such, the print head 202 may skip the deposition of material at specific regions in subsequent layers 102b, 102c, 102n of material deposition so as to define the passages 104 in the component 100 while being traced by the print head 202. Moreover, the skipping of the deposition at specific regions in a given layer may be configured to correspond with similar specific regions in subsequent layers 102b, 102c, 102n to define the passages 104 as contiguous passages. In various embodiments of the present disclosure, it is hereby envisioned that a diameter ‘D’ of the passages 104 disclosed herein may lie in the order of a few microns to a few millimeters depending on an overall geometry for e.g., size and/or shape of the traced component 100.

In embodiments of the present disclosure, the specific regions from each of the subsequent layers 102b, 102c, 102n at which the passages 104 are defined may beneficially correspond to locations in the component 100 adjacent to which enhanced hardness may be desired. Various parameters related to each of the passages 104 in the traced component 100 such as, but not limited to, a geometry of the passages 104, an aspect ratio of the passages 104; a number of the passages 104 in the traced component 100; a spatial distribution of the passages 104 in the traced component 100 may be selected based on specific requirements of an application associated with a hardness or localized hardness of the component 100.

Referring to FIGS. 1 and 2, the print head 202 defines eight passages 104a-h in the traced component 100. Moreover, each of these passages 104 have been shown to have a generally cylindrical shape. However, in alternative embodiments, it may be noted that a number of passages 104 in the traced component 100; and a geometry i.e., a size and/or shape of each passage 104 in the traced component 100 may vary depending on specific requirements of an application associated with hardness or localized hardness of the component 100. Though each of the passages 104 have been shown in the same plane, the passages 104 may be located in different planes and location in the component 100.

In embodiments of the present disclosure, it is also contemplated to use Finite Element Analysis (FEA) to determine the above described parameters relating to the passages 104 that are to be defined in the traced component 100. Moreover, FEA may also be used to optimize a spatial distribution of the passages 104 in the traced component 100 depending on specific requirements of an application. For example, for a specific application, it may be desired to produce the component 100 that has greater hardness at one location within the component 100 as compared to remainder of the component 100. In such a case, FEA may be beneficially used to determine a location of each passage 104 in the traced component 100 and hence, the spatial distribution for the passages 104 in the traced component 100. Although FEA has been discussed herein, numerous other algorithms/software/programs known to persons skilled in the art may be employed in lieu of the FEA for performing a modeling and analysis of the traced component 100. Such algorithms/software/programs may also be contemplated for use in determining the parameters associated with the passages 104 to be formed in the traced component 100. Alternatively, the control system 206 may issue commands to the print head 202, through a user input device (not shown), to execute specific steps or functions.

In an embodiment of this disclosure, it is contemplated that some of the passages 104 defined in the traced component 100 may be stand-alone passages 104 while a remainder of the passages 104 defined in the traced component 100 may be interconnected with channels 106a-c (herein after collectively denoted as numeral 106, unless referring to a specific channel) therebetween so as to represent a matrix or network of passages 104. Referring to FIG. 2, passages 104a, 104f, 104g, and 104h are the stand-alone passages 104 while passages 104a, 104e; passages 104b, 104c; and passages 104d, 104e are interconnected with one another using channels 106a, 106b and 106c respectively. It may be noted that the channels 106a, 106b and 106c used to connect the passages 104a, 104e; 104b, 104c; and 104d, 104e are defined while tracing the component 100 using the 3D printing system 200 itself. As is the case with passages 104, it may be noted that a geometry of each channel 106 for e.g., aspect ratio, size, and/or shape of each channel 106; and a spatial distribution of the channels 106 required in the traced component 100 may also be optimized by the use of FEA or other methods/software/programs disclosed herein prior to tracing the component 100 using the additive manufacturing process.

Moreover, in an embodiment as shown in FIG. 2, the channel 106b and 106c connect adjacent passages 104b, 104c and 104d, 104e respectively. In another embodiment, the channel 106a connects two non-adjacent passages 104a, 104e. In yet another embodiment, it may be contemplated to trace the component 100 using the additive manufacturing process of FIG. 1 such that only stand-alone passages 104 are defined in the traced component 100. Alternatively, in another embodiment, the component 100 may be traced using the additive manufacturing process of FIG. 1 such that only a network of passages 104 including channels 106 are defined in the traced component 100. Therefore, notwithstanding anything contained in the document, it should be appreciated that any configuration and/or spatial distribution of the passages 104 and channels 106 may be used so as to form the stand-alone passages 104 and/or the network of passages 104 in the traced component 100. Moreover, persons skilled in the art will acknowledge that a number of stand-alone passages 104 and a number of interconnected passages 104 may be suitably selected depending on hardness characteristics (for e.g., localized hardness) required in the traced component 100. Such hardness characteristics may be determined from specific requirements associated with an application in which the component 100 will be used. Further explanation pertaining to the function of the passages 104, stand-alone or networked, and the channels 106 will be explained later in the document.

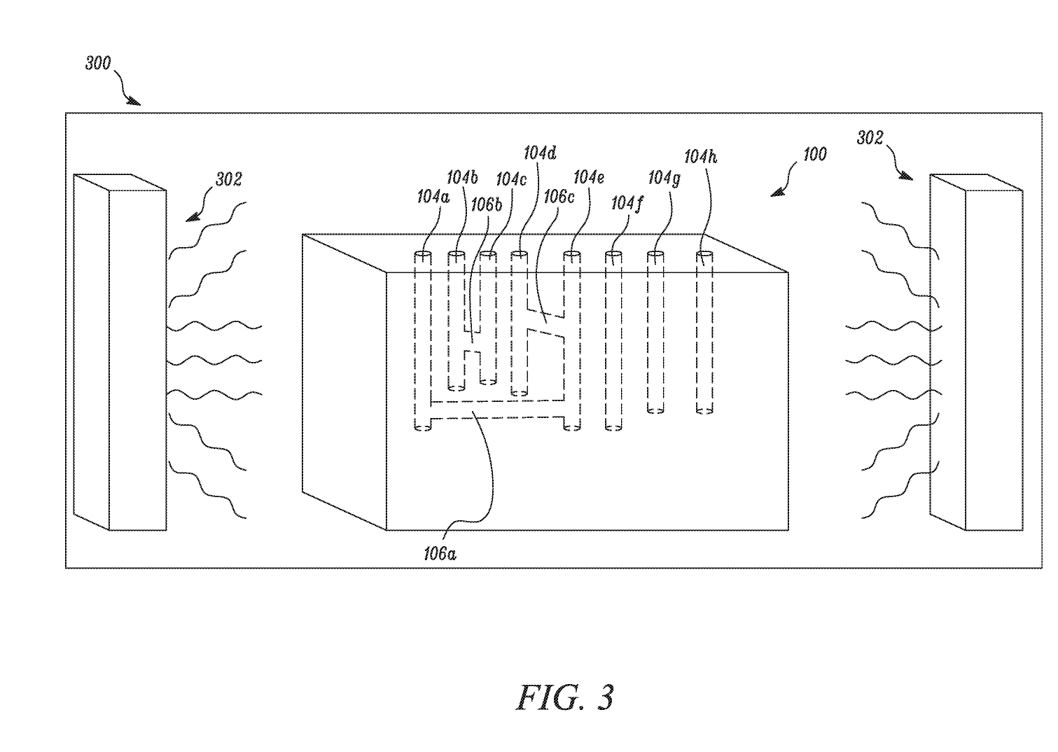

Upon forming the component 100 using the additive manufacturing process, the component 100 is heated in a pre-defined chamber 300 using various heat sources 302, as shown in the embodiment of FIG. 3. The pre-defined chamber 300 may be embodied in the form of a vacuum chamber, or a furnace that utilizes a pre-defined atmosphere. It should be noted that a scope of the pre-defined chamber 300 is not limited to the vacuumed chamber or the atmospheric furnace, rather the scope of the pre-defined chamber 300 extends to include various other types of controlled environments known to persons skilled in the art without deviating from the spirit of the present disclosure. Moreover, the heat sources 302 disclosed herein may be configured to heat the traced component 100 using conduction, convection, radiation, or any other means known to persons skilled in the art. However, as will be acknowledged by one skilled in the art, subjecting the traced component 100 to the heat sources 302 may allow the heat from the heat sources 302 to be transferred to material(s) of the traced component 100 that are located adjacent to the passages 104. Moreover, the heating of the traced component 100 may be carried out until a temperature of the traced component 100 is elevated to a pre-determined value, the value being determined on the basis of subsequent embodiments of the present disclosure disclosed hereinafter.

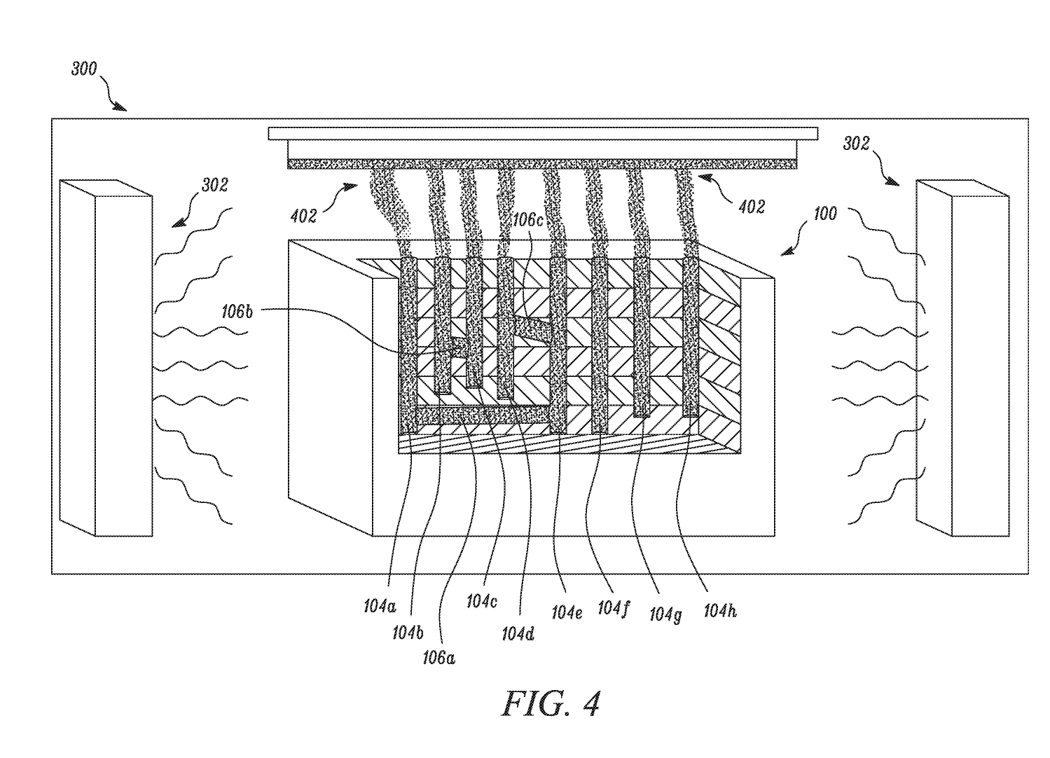

Upon heating of the traced component 100 to the pre-determined value, the traced component 100 is then subject to a gaseous medium 402, as shown in the embodiment of FIG. 4. Specifically, when subjecting the traced component 100 to the gaseous medium 402, the passages 104 located in the traced component 100 are infused with the gaseous medium 402, the gaseous medium 402 being associated with a nitriding process, a ferritic-nitro-carburizing process, a carbo-nitriding process, or a carburizing process. It should be noted that the aforesaid processes of heating the traced component 100 and infusing the gaseous medium 402 into the passages 104 may be carried out simultaneously (as shown in FIG. 4), in a tandem manner, or in any other manner known to persons skilled in the art. As such, heating of the traced component 100 and infusion of the gaseous medium 402, when carried out simultaneously are characteristic of a heat-treatment process. To that end, the pre-determined elevated temperature to which the traced component 100 is heated may depend on the heat treatment process i.e., the nitriding process, the ferritic-nitro-carburizing process, the carbo-nitriding process, or the carburizing process and the type of gaseous medium 402 used in a given heat-treatment process.

As each of the aforesaid processes may use a different gaseous medium 402, the pre-determined value of temperature to which the traced component 100 should be heated may vary. In an example, if carburizing is required, carbon monoxide gas may be used as the gaseous medium 402 and such carbon monoxide gas may entail that the traced component 100 be heated to an elevated temperature of about 900° C. to 950° C. Similarly, other pre-determined elevated temperature values may be employed when infusing the passages 104 with other gaseous mediums 402 depending on the type of heat treatment process used on the traced component 100. Moreover, such infusion of the gaseous medium 402 may be carried out for a pre-defined period of time for e.g., until a desired amount of hardness or at least some part of the desired hardness is achieved in the material(s) adjacent to the passages 104 in the traced component 100.

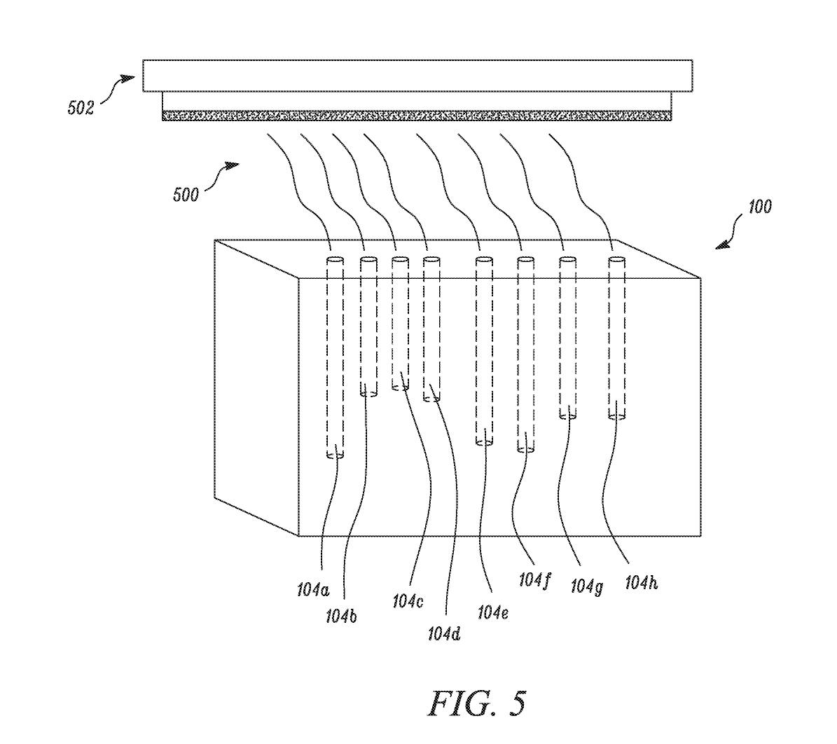

Additionally or optionally, the traced component 100 is quenched using a quenching fluid 500, as shown in the embodiment of FIG. 5. In one embodiment, the traced component 100 may be heated as shown in FIG. 3 and then directly quenched so as to fill the passages 104 of the traced component 100 with the quenching fluid 500. In another embodiment, the traced component 100 is quenched after infusion of the gaseous medium 402 into the passages 104 such that the passages 104 are now filled with the quenching fluid 500. The quenching of the traced component 100 may typically be carried out until the passages 104 in the traced component 100 are filled with the quenching fluid 500 for a pre-defined period of time. In yet another embodiment, it is also contemplated to terminate the hardening of the traced component 100 by merely infusing the passages 104 with the gaseous medium 402 thereby doing away with the quenching process. Therefore, it should be noted that the traced component 100 may be hardened by any number of processes including heating and quenching the traced component 100; heating and infusing the traced component 100; or heating, infusing the gaseous medium 402, and subsequently quenching the traced component 100. Moreover, it is hereby envisioned that such quenching process, if carried out with or without the infusion process preceding the quenching process, typically converts, for example, a pre-determined amount of austenitic steel to martensitic steel for obtaining the desired amount of hardness and residual stress in the traced component 100.

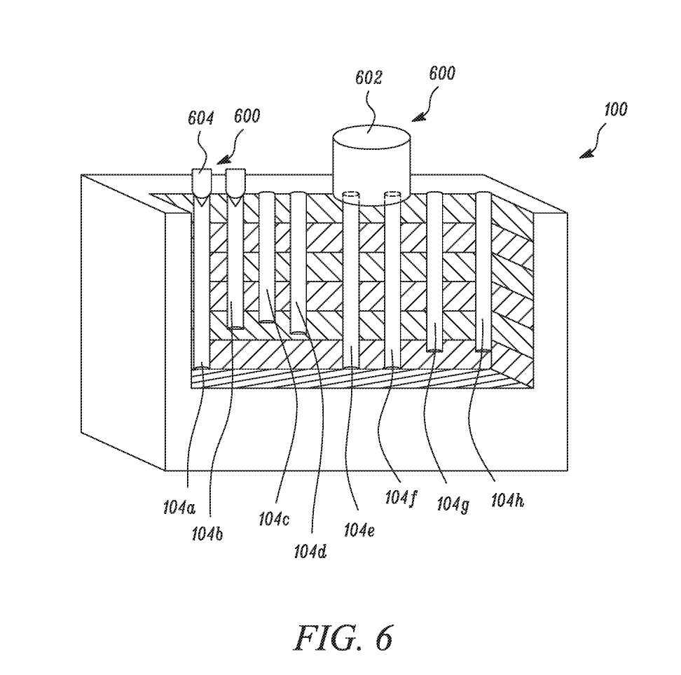

The quenching fluid 500 disclosed herein may include fluids such as water, oil, or any other gaseous or liquid fluid known to persons skilled in the art. In an embodiment, the passages 104 may be quenched by a spray of quenching fluid 500 that is dispensed using suitable dispensing devices 502 for e.g., a spray head, as shown in the embodiment of FIG. 5. In another embodiment as shown in FIG. 6, specially fabricated structures and/or devices 600 may be implemented for performing the quenching process. For example, as shown in FIG. 6, the specially fabricated structures and/or devices 600 for quenching the traced component 100 includes quench pads 602 that serve to store and dispense the stored quenching fluid 500 into the passages 104 of the traced component 100. In another example as shown in FIG. 6, the specially fabricated structures and/or devices 600 for quenching the traced component 100 may also include quench plugs 604 that serve to plug the one or more passages 104 on the component 100. Such quench plugs 604 may be configured to direct quenching fluid to a specific location of the part, or to restrict an egress of quenching fluid 500 from the passages 104.

In various embodiments of this disclosure, it is to be noted that the channels 106 beneficially help to route the gaseous medium 402 and/or the quenching fluid 500 between passages 104 of the traced component 100 as the heated component 100 undergoes the infusion process and/or the quenching process.

Upon completion of the aforesaid sequence of processes i.e., a) subjecting the traced component 100 to heating and infusing the gaseous medium 402 into passages 104 of the traced component 100; b) heating the traced component 100 and then quenching with the quenching fluid 500; or c) heating the traced component 100, infusing the gaseous medium 402 into passages 104 of the traced component 100 and subsequently quenching the passages 104 of the traced component 100 with the quenching fluid 500, with or without using quench pads 602, or quench plugs 604, it may be contemplated, additionally or optionally, to seal off an opening to the passages 104 with material(s) with which the traced component 100 has been manufactured in the additive manufacturing process, or material(s) that are different from the base material depending on specific requirements of an application. For example, if the base material used to form or trace the component 100 during the additive manufacturing process is steel, a secondary material such as, but not limited to, brass, bronze, resins, polymers and the like may be contemplated for use in sealing off the passages 104 and creating a contiguous surface of the traced component 100. In various other embodiments, any thermal process, such as steam oxidizing, may also be used to seal the surface or to modify the surface properties.

### INDUSTRIAL APPLICABILITY

Embodiments of the present disclosure have applicability for use and implementation in producing hardened components using, at least in part, an additive manufacturing process. In many cases, it is observed that with the use of traditionally known techniques, a hardness of the component was limited to an outer surface of the component and in some cases, such hardness may also be exhibited by zones immediately underlying the outer surface of the component. However, with use of embodiments disclosed herein, components may be easily formed to a desired amount of hardness and such hardness may be exhibited at a greater depth of the component as compared to traditionally known techniques.

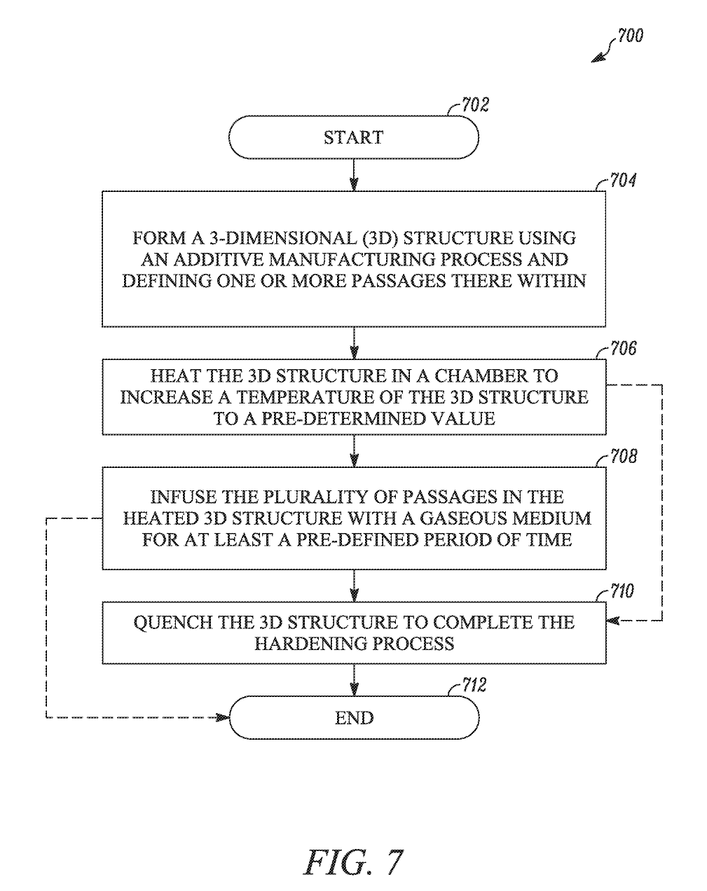

FIG. 7 illustrates a method 700 of producing the hardened component 100, in accordance with embodiments of the present disclosure. The method initiates at step 702. At step 704, the method includes forming the 3-dimensional component 100 using an additive manufacturing process. As shown in FIG. 1, the 3D printing system 200 may be used to form the component 100 by depositing the material layer by layer.

Further at step 706, the method 700 may involve defining passages 104 in the traced component 100. At step 708, the method 700 includes heating the component 100 in a pre-defined chamber 300 to increase the temperature of the traced component 100 to a predetermined value. As shown in FIG. 5, the heat source 302 heats the traced component 100 in the pre-defined chamber 300. In one embodiment, at step 708, the method 700 optionally includes infusing the gaseous medium 402 through the passages 104 in the heated component 100 for at least a pre-defined period of time. In another embodiment, at step 710, the method 700, additionally or optionally, includes a quenching process.

In one embodiment as shown with dotted lines between steps 708 and 712 of FIG. 7, the step of quenching to be performed at step 710 may not be performed depending on specific requirements of an application as only the heating and infusion may allow to obtain the desired hardness in the traced component 100. For example, if the heat treatment process includes a nitriding process or ferritic-nitro-carburizing process, the traced component 100 may have the required hardness obtained from the respective heat-treatment process and therefore, the method 700 may not require the quenching process at step 710 and subsequently will terminate at 712. However, in an alternative embodiment as shown at steps 708 and 710 of FIG. 7, if the heat treatment process includes carburizing or carbo-nitriding, the method 700 may further include subjecting the traced, heated, and infused component 100 to an additional quenching process to obtain the desired amount of hardness in the component 100. However, in yet another embodiment as shown with dotted lines between steps 706 and 710, the method 700 may additionally include quenching the passages 104 of the component 100 with the quenching fluid 500 directly after heating the traced component 100.

The method 700 of the present disclosure for manufacturing the component 100 through additive manufacturing process and defining one or more passages 104 there within, may provide a deeper hardened depth in the component 100 for the post treatment process through the use of at least one of infusion, and quenching. Also, the method 700 allows to design a specific hardness profile and the internal residual stress profile through the use of channels 106.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A method of producing a three-dimensional (3D) component, the method comprising:
forming a 3D structure using an additive manufacturing process, wherein forming the 3D structure includes defining one or more passages there within;
heating the 3D structure in a pre-defined chamber to increase a temperature of the 3D structure to a pre-determined value; and
performing at least one of:
infusing the one or more passages defined in the heated 3D structure with a gaseous medium for at least a pre-defined period of time; and
quenching the one or more passages in the 3D structure with a quenching fluid for a pre-defined period of time.

2. The method of claim 1, wherein the one or more passages from the plurality of passages defined in the 3D structure are stand-alone passages.

3. The method of claim 1, wherein the one or more passages from the plurality of passages are configured to be mutually interconnected to define a network of passages in the 3D structure.

4. The method of claim 1, wherein quenching the one or more passages in the 3D structure is performed subsequent to heating the 3D structure and infusing the gaseous medium into the one or more passages.

5. The method of claim 1, wherein the gaseous medium is associated with at least one of: a nitriding process, a ferritic-nitro-carburizing process, a carbo-nitriding process, and a carburizing process.
